(19) United States
(12) Patent Application Publication
(10) Pub. No.: US 2023/0303898 A1
(43) Pub. Date: Sep. 28, 2023

(54) (METH)ACRYLATE STRUCTURAL ADHESIVES AND METHODS

(71) Applicant: 3M INNOVATIVE PROPERTIES COMPANY, St. Paul, MN (US)

(72) Inventors: Anthony J. Ostlund, Forest Lake, MN (US); Wayne S. Mahoney, St. Paul, MN (US); Michael A. Kropp, Cottage Grove, MN (US); Kristine Klimovica, St. Paul, MN (US); Carol-Lynn Spawn, Stillwater, MN (US)

(21) Appl. No.: 18/020,599

(22) PCT Filed: Aug. 11, 2021
(86) PCT No.: PCT/IB2021/057410

§ 371 Date: Feb. 9, 2023

Related U.S. Application Data
(60) Provisional application No. 63/064,198, filed on Aug. 11, 2020.

(51) Int. Cl. C09J 133/10; C09J 4/06; C09J 11/06; C09J 11/04; C09J 7/30

(52) U.S. Cl. CPC C09J 133/10; C09J 4/06; C09J 11/06; C09J 11/04; C09J 7/30; C09J 2433/00

(57) ABSTRACT

Provided are curable (meth)acrylate structural adhesive compositions comprising a cyclic imide-containing (meth)acrylate monomer and a crosslinker, and methods, particularly methods of use.

### CROSS-REFERENCE TO RELATED APPLICATION

This application claims priority to U.S. Provisional Application No. 63/064,198, filed Aug. 11, 2020, the disclosure of which is incorporated by reference in its entirety herein.

### BACKGROUND

Structural adhesives are known to be useful for bonding one substrate to another, e.g., a metal to a metal, a metal to a plastic, a plastic to a plastic, a glass to a glass. Structural adhesives are attractive alternatives to mechanical joining methods, such as riveting or spot welding, because structural adhesives distribute load stresses over larger areas rather than concentrating such stresses at a few points.

Though known structural adhesives may have good high-temperature performance and durability, the rigid bond these structural adhesives create after curing can lead to poor impact resistance of the bonded parts and subsequent bond failure. Additionally, adhesives that form rigid bonds have high and uneven stresses distributed throughout the bond, with the stress at the edges of the bond typically higher than the stress in the middle of the bond. The high stress of rigid structural adhesives can lead to the undesirable distortion of bonded materials.

One approach used in the industry to enhance flexibility and toughness of structural adhesives is the incorporation of elastomeric materials that can be dissolved or dispersed in a curable adhesive composition. Examples of such elastomeric materials may include, for example, a methyl methacrylate-butadiene-styrene copolymer (“MBS”), an acrylonitrile-styrene-butadiene copolymer, a linear polyurethane, an acrylonitrile-butadiene rubber, a styrene-butadiene rubber, a chloroprene rubber, a butadiene rubber, and natural rubbers. These elastomeric material additives can, however, lead to high viscosity of the liquid adhesive compositions that may result in handling challenges during use. Additionally, in the case of butadiene or other conjugated diene rubbers the elastomeric material additives may reduce the resistance to oxidation of the structural adhesive that may lead to bond failure.

Good adhesion of a structural adhesive to glass (non-fritted or fritted) is often quite difficult to achieve without the use of a primer or a reactive hot melt (e.g., polyurethane) adhesive. Structural adhesive compositions that include acrylates are well known to be rapidly curing and insensitive to surface preparation; however, such adhesives when used on glass are easily degraded by high humidity conditions via transesterification reactions and hydrolysis.

### SUMMARY

What is needed is a curable adhesive composition that is rapidly curing to form a structural adhesive, preferably one that bonds to glass (e.g., glass to glass or metal to glass), ideally without the need for a primer, and that has low rates of hydrolysis and transesterification.

In one aspect, provided is a curable (meth)acrylate structural adhesive composition comprising: a cyclic imide-containing (meth)acrylate monomer; a crosslinker; and a cure initiator system; wherein the crosslinker is a compound represented by the formula:

L-(R¹)q
wherein each R¹ is independently selected from a functional group represented by the formula:

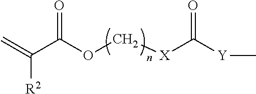

wherein:
   each R² is independently hydrogen or methyl;
   n is an integer from 1 to 5, inclusive;
   X is O, S, or NH; and
   Y is a single bond or a divalent group represented by the formula:

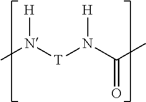

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof,
q is an integer of at least 2; and
L is an q-valent organic polymer (preferably, having a number average molecular weight of from 4000 to 54000 grams per mole versus a polystyrene standard) comprising a monomer unit selected from the group consisting of monomer units represented by the formulas:

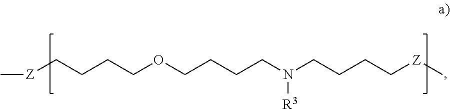

wherein R³ is a hydrogen or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH;

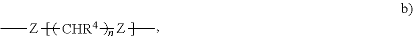

wherein n is an integer from 1 to 5, inclusive, each R⁴ is independently hydrogen or alkyl, and each Z is independently O, S, or NH;

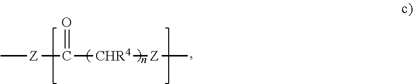

wherein n is an integer from 1 to 5, inclusive, each R⁴ is independently hydrogen or alkyl, and each Z is independently O, S, or NH;

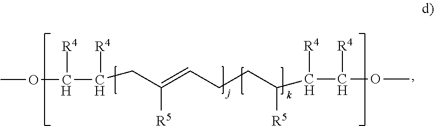

wherein j is a whole number less than or equal to 30, k is a whole number less than or equal to 30, each R⁴ is independently hydrogen or alkyl, and each R⁵ is independently a C₁₀ to C₁₅ alkyl group or a C₁₀ to C₁₅ alkenyl group, wherein j and k are not both zero, and wherein the moieties having the j and k subscripts are distributed randomly in the carbon chain:

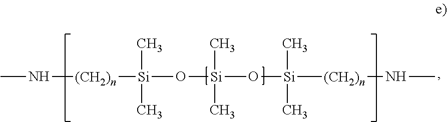

wherein m is an integer from 10 to 330 inclusive, n is an integer from 1 to 5, inclusive; and
mixtures thereof.

In some embodiments, the q-valent organic polymer L comprises less than 26000 grams per mole versus a polystyrene standard of monomer unit e) if it is present.

In another aspect, provided is a method of bonding a first substrate to a second substrate, the method comprising:
providing a curable (meth)acrylate structural adhesive composition as described herein, and an accelerator to form a curable adhesive mixture;
applying the curable adhesive mixture to at least a portion of one surface of the first substrate;
covering the curable adhesive mixture (on the surface of the first substrate) at least partially with at least a portion of one surface of the second substrate; and
allowing the curable adhesive mixture to cure and form a structural (meth)acrylate adhesive (thereby bonding the first and second substrates).

The term “aliphatic” refers to a saturated or unsaturated linear, branched, or cyclic hydrocarbon group. In certain embodiments, the term aliphatic refers to a saturated or unsaturated linear or branched hydrocarbon group. This term is used to encompass alkyl, alkenyl, and alkynyl groups, for example.

The term “alkyl” refers to a monovalent group that is a radical of an alkane, which is a saturated hydrocarbon. The alkyl can be linear, branched, cyclic, or combinations thereof and typically has 1 to 20 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. The radical centers of the alkylene can be on the same carbon atom (i.e., an alkylidene) or on different carbon atoms.

The term “alkoxy” refers to a monovalent group of formula —OR where R is an alkyl.

The term “aromatic” or “aryl” refers to a group that has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a polyvalent, aromatic, such as phenylene, naphthalene, and the like.

The term “cyclic” means a closed ring hydrocarbon group that is classified as an alicyclic group, aromatic group, or heterocyclic group. The term “alicyclic group” means a cyclic hydrocarbon group having properties resembling those of aliphatic groups. “Alicyclic ring” and “aliphatic ring” are used interchangeably herein. The term “aromatic group” or “aryl group” means a mono- or polynuclear aromatic hydrocarbon group.

The term “heteroalkylene” refers to an alkylene having one or more —CH₂— groups replaced with a thio, oxy, or -NR^{b}-where R^{b} is hydrogen or alkyl. The heteroalkylene can be linear, branched, cyclic, or combinations thereof. Exemplary heteroalkylene include alkylene oxides or poly(alkylene oxides). That is, the heteroalkylenes include at least one group of formula —(R—O)— where R is an alkylene.

The term “(meth)acrylate” or “(meth)acrylic acid” is used herein to denote the corresponding acrylate and methacrylate. Thus, for instance, the term “(meth)acrylic acid” covers both methacrylic acid and acrylic acid, and the term “(meth)acrylate” covers both acrylates and methacrylates. The (meth)acrylate or the (meth)acrylic acid may consist only of the methacrylate or methacrylic acid, respectively, or may consist only of the acrylate or the acrylic acid, respectively, yet may also relate to a mixture of the respective acrylate and methacrylate (or acrylic acid and methacrylic acid).

As used herein, the term “or” is generally employed in its usual sense including “and/or” unless the content clearly dictates otherwise.

As used herein, the term “and/or” is used to indicate one or both stated cases may occur, for example A and/or B includes, (A and B) and (A or B).

As used herein, the term “room temperature” refers to a temperature in the range of 20° C. to 25° C.

As used herein, the term “substantially free” means less than 1% by weight, less than 0.5% by weight, or less than 0.10% by weight, of a given component in a composition based on the total weight of the composition.

The term “glass transition temperature” or “T_{g}” refers to the temperature at which a material changes from a glassy state to a rubbery state. In this context, the term “glassy” means that the material is hard and brittle (and therefore relatively easy to break) while the term “rubbery” means that the material is elastic and flexible. For polymeric materials, the T_{g} is the critical temperature that separates their glassy and rubbery behaviors. If a polymeric material is at a temperature below its T_{g}, large-scale molecular motion is severely restricted because the material is essentially frozen. On the other hand, if the polymeric material is at a temperature above its T_{g}, molecular motion on the scale of its repeat unit takes place, allowing it to be soft or rubbery. Any reference herein to the T_{g} of a monomer refers to the T_{g} of a homopolymer formed from that monomer. The glass transition temperature of a polymeric material is often determined using methods such as Dynamic Mechanical Analysis (“DMA”) or Differential Scanning Calorimetry (e.g., Modulated Differential Scanning Calorimetry). Alternatively, the glass transition of a polymeric material can be calculated using the Fox Equation if the amount and T_{g} of each monomer used to form the polymeric material are known.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### DETAILED DESCRIPTION OF ILLUSTRATIVE EMBODIMENTS

The present disclosure provides is a curable (meth)acrylate structural adhesive composition including: a cyclic imide-containing (meth)acrylate monomer; a crosslinker; and a cure initiator system. Curable compositions in embodiments of the present disclosure may further have the advantages of yielding bonded constructions, typically including glass (non-fritted or fritted), whether it is glass bonded to glass or metal bonded to glass.

An adhesive (which may also be a sealant) prepared from a curable composition of the present disclosure may be prepared by combining a curable structural adhesive composition of the present disclosure with an accelerator such as, for example, the accelerator from 3M SCOTCH-WELD DP8410NS Acrylic Adhesive (3M Company, St. Paul, MN). In some embodiments, the adhesive may include 10 parts of the curable composition and 1 part of the accelerator.

Adhesives of the present disclosure may be used, for example, to bond a first substrate to a second substrate to provide a bonded article. Many types of substrates may be bonded with elastomeric products of the present disclosure, such as, for example, metals (e.g., aluminum), plastics (e.g., a polyamide), and glasses. In particularly preferred embodiments, the substrate is a glass, whether fritted or non-fritted, and the glass is bonded to another glass, or the glass is bonded to a metal.

In some embodiments, a first substrate may be bonded to a second substrate by mixing a curable structural adhesive composition of the present disclosure with an accelerator to form a curable adhesive mixture, applying the curable adhesive mixture to at least a portion of one surface of the first substrate, covering the curable adhesive mixture (which is disposed on the surface of the first substrate) at least partially with at least a portion of one surface of the second substrate, and allowing the curable adhesive mixture to cure and form a structural adhesive, there by bonding the first and second substrates together.

In some embodiments, the portion of one surface of the first substrate is not subjected to a surface treatment (e.g., corona, flame, abrasion, or chemical primer) before applying the curable adhesive mixture thereto. In some embodiments, the portion of one surface of the second substrate is not subjected to a surface treatment (e.g., corona, flame, abrasion, or chemical primer) before contacting the curable adhesive mixture therewith. In some embodiments the first substrate and the second substrate are different materials such as, for example, a metal and a glass. In some embodiments, the bonded article may be, for example, an automotive component, an electronic device, or a component of an electronic device.

After curing, the curable structural adhesive composition of the present disclosure yields bonded constructions displaying high adhesion, elongation, and impact resistance on a variety of substrates, even when the bonded substrate receives no surface treatment prior to bonding. Curable compositions in embodiments of the present disclosure may yield adhesives providing bonded constructions that display little to no bond-line read through, a visible distortion of bonded materials, which may be particularly useful in automotive and aerospace applications, among others. Curable compositions in embodiments of the present disclosure may yield adhesives particularly suitable for use in portable electronic devices requiring tough adhesives that can survive the impact associated with drop tests. Curable compositions in embodiments of the present disclosure may provide adhesive compositions exhibiting stretch release, which can enable rework of parts bonded with these adhesives. Curable compositions in embodiments of the present disclosure may provide sealants that resist hydrolysis upon heat/humidity aging, which may be particularly useful, for example, in applications where the sealant is exposed to warm, humid conditions over prolonged periods of time.

The curable compositions are substantially free of liquid rubber materials (and often even substantially free of silane adhesion promoters, isocyanates, urethanes, thiols, epoxies), and yet yield bonded constructions displaying high adhesion (i.e., >1000 psi in a typical Overlap Shear Test), elongation (i.e., values greater than 10%, greater than 25%, greater than 50%, greater than 100%, or greater than 400%), and impact resistance (e.g., >2 J), even if the bonded substrate (e.g., glass, metal, polymer) receives no surface treatment (e.g., corona, flame, abrasion, chemical primer) prior to bonding, due to the inclusion of novel crosslinkers and monomers described below. Such constructions display little to no bond-line read through, may provide adhesive compositions exhibiting stretch release, which may enable rework of parts bonded with these adhesives, and may provide sealants that resist hydrolysis upon heat/humidity aging. In some cases, the compositions of the present disclosure allow components to be disassembled with heat and non-wire string.

In some embodiments, the structural (meth)acrylate adhesive formed from the curable composition described herein has a minimum ultimate elongation of at least 50%, at least 100%, at least 200%, at least 400%, at least 600%, or at least 800%, and minimum overlap shear strength of at least 1000 psi, at least 1100 psi, at least 1200 psi, at least 1300 psi, or at least 1400 psi. In some embodiments, the structural (meth)acrylate adhesive formed from the curable composition described herein may exhibit stretch release. In some embodiments the structural (meth)acrylate adhesive formed from the curable composition described herein may resist hydrolysis upon heat/humidity aging.

The tan delta peak in dynamic mechanical analysis (“DMA”) reflects the ability of a material to store or dissipate energy. A broader tan delta peak suggests that a material can dissipate energy and survive impacts over a larger range of frequencies and/or temperatures.

In some embodiments, the structural adhesive may exhibit a cured T_{g} above 70° C. (determined using DMA), which appears to give sufficient cohesive integrity to add benefit to adhesion. Generally, if the T_{g} is lower than this, the adhesion can be too weak to hold the load.

### Cyclic Imide-Containing (Meth)acrylate Monomer

The cyclic imide-containing (meth)acrylate monomer includes a cyclic imide group of the following formula:

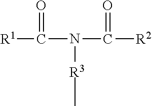

wherein R¹ and R² are joined to form a ring system that includes one or more rings (typically, two rings), and R³ is an alkylene group (e.g., a C₁-C₈ alkylene group, and typically, an ethylene group) bound to a (meth)acrylate group (—O—C(O)—C(R)═CH₂) wherein R═H or CH₃. In some embodiments, R is hydrogen. In some embodiments, R is CH₃. The ring system may include aliphatic ring(s), aromatic ring(s), or both. In certain embodiments, the ring system includes only aliphatic rings (typically, two aliphatic rings). In some embodiments, the ring system includes one or two 5- to 8- (in some embodiments, 5- to 7- or 5- to 6-) membered rings. In some embodiments, R³ is an alkylene group having 2 to 8, 2 to 6, or 2 to 4 carbon atoms.

In certain embodiments, the cyclic imide-containing (meth)acrylate monomer is a methacrylate of the following formula:

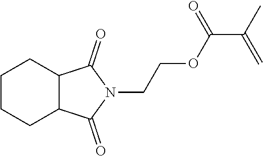 [SMILES: C=C(C)C(=O)OCCN1C(=O)C2CCCCC2C1=O]

(2-(hexahydrophthalimido)ethyl methacrylate). In certain embodiments, the cyclic imide-containing (meth)acrylate monomer is the acrylate analogue thereof, (2-(hexahydrophthalimido)ethyl acrylate).

Typically, the methacrylate monomer (which is available from Miwon North America (Exton, PA) under the trade designation MIRAMER M1089) is preferred over the analogous acrylate, at least due to greater stability and cured T_{g} (preferably, above 70° C.) of the resultant structural adhesive.

In certain embodiments of the present disclosure, the curable composition commonly includes at least 5 wt-% of the cyclic imide-containing (meth)acrylate monomer. In certain embodiments of the present disclosure, the curable composition commonly includes up to 50 wt-% of the cyclic imide-containing (meth)acrylate monomer.

### Additional Monofunctional Monomers

The curable composition further comprises a monofunctional (meth)acrylate monomer. Examples of monofunctional (meth)acrylate monomers useful in embodiments of the present disclosure include 2-phenoxyethyl (meth)acrylate, cyclohexyl (meth)acrylate, benzyl (meth)acrylate, isobornyl (meth)acrylate, acid-functional monomers such as (meth)acrylic acid, alkoxylated lauryl (meth)acrylate, alkoxylated phenol(meth)acrylate, alkoxylated tetrahydrofurfuryl (meth)acrylate, caprolactone (meth)acrylate, cyclic trimethylolpropane formyl (meth)acrylate, ethylene glycol methyl ether methacrylate, ethoxylated nonyl phenol (meth)acrylate, isodecyl (meth)acrylate, isooctyl (meth)acrylate, lauryl (meth)acrylate, octadecyl (meth)acrylate (stearyl (meth)acrylate), tetrahydrofurfuryl (meth)acrylate, tridecyl (meth)acrylate, tetrahydrofurfuryl (meth)acrylate, allyl (meth)acrylate, methyl (meth)acrylate, ethyl (meth)acrylate, n-propyl (meth)acrylate, n-butyl (meth)acrylate, isobutyl (meth)acrylate, n-hexyl (meth)acrylate, 2-ethylhexyl (meth)acrylate, n-octyl (meth)acrylate, n-decyl (meth)acrylate, n-dodecyl (meth)acrylate, 2-hydroxyethyl (meth)acrylate, 2- and 3-hydroxypropyl (meth)acrylate, 2-methoxyethyl(meth)acrylate, 2-ethoxyethyl (meth)acrylate, 2- or 3-ethoxypropyl (meth)acrylate, 2-(2-ethoxyethoxy)ethyl acrylate, glycidyl (meth)acrylate, phosphonate-functional (meth)acrylate monomers (for example, the SIPOMER PAM resins from Solvay Specialty Polymers USA, LLC or those from Miwon North America (Exton, PA) under the trade designation MIRAMER SC1400 and MIRAMER SC1400A), N-(2-(2-oxo-1-imidazolidinyl)ethyl)-meth acrylamide (methacrylamidoethyl ethyleneurea (“MAEEU”) available from Solvay Specialty Polymers USA, LLC. under the trade designation SIPOMER WAM II), and the like, and combinations thereof.

Specific examples of monoacrylate monomers useful in embodiments of the present disclosure include isobornyl acrylate (commercially available from SARTOMER under the trade designation SR506, or from Evonik Performance Materials GmbH under the trade designation VISIOMER IBOA), isobornyl methacrylate (commercially available from Sartomer under the trade name SR423A or from Evonik Performance Materials GmbH under the trade name VISIOMER IBOMA), 2-phenoxyethyl methacrylate (commercially available from SARTOMER under the trade designation SR340), cyclohexyl methacrylate (commercially available from Evonik Performance Materials GmbH under the trade designation VISIOMER c-HMA), benzyl methacrylate (commercially available from Miwon North America (Exton, PA) under the trade designation MIRAMER M1183), phenyl methacrylate (commercially available from Miwon North America (Exton, PA) under the trade designation MIRAMER M1041), allyl methacrylate (commercially available from Evonik Performance Materials GmbH under the trade designation VISIOMER AMA), 2-hydroxyethyl methacrylate (commercially available from Evonik Performance Materials GmbH under the trade designation VISIOMER HEMA 97 and HEMA 98), hydroxypropyl methacrylate (commercially available from Evonik Performance Materials GmbH under the trade designation VISIOMER HPMA 97 and HPMA 98), ultra-high purity 2-hydroxyethyl methacrylate (commercially available from Evonik Performance Materials GmbH under the trade designation VISIOMER UHP HEMA), methyl methacrylate (commercially available from Evonik Performance Materials GmbH under the trade designation VISIOMER MMA), methacrylic acid (commercially available from Evonik Performance Materials GmbH under the trade designation VISIOMER GMAA), n-butyl methacrylate (commercially available from Evonik Performance Materials GmbH under the trade designation VISIOMER n-BMA), isobutyl methacrylate (commercially available from Evonik Performance Materials GmbH under the trade designation VISIOMER i-BMA), glycerol formal methacrylate (commercially available from Evonik Performance Materials GmbH under the trade designation VISIOMER GLYFOMA), 2-(2-butoxyethoxy)ethyl methacrylate (commercially available from Evonik Performance Materials GmbH under the trade designation VISIOMER BDGMA), lauryl methacrylate (commercially available from BASF (Florham Park, NJ) under the trade designation LMA 1214 F, polypropylene glycol monomethacrylate (commercially available from Miwon North America (Exton, PA) under the trade designation MIRAMER M1051), β-methacryloyl oxyethyl hydrogen succinate (commercially available from Shin-Nakamura Co. LTD (Arimoto, Japan) under the trade designation NK ESTER SA), 2-isocyanatoethyl methacrylate (commercially available from Showa Denko K.K. (Tokyo, Japan) under the trade designation KarenzMOI), 2-(methacryloyloxy)ethyl phthalate mono ((HEMA phthalate) commercially available as product number X-821-2000 from ESSTECH, Inc., Essington, PA), 2-(methacroyloxy)ethyl maleate ((HEMA maleate) commercially available as product number X-846-0000 from ESSTECH, Inc., Essington, PA), methoxy diethylene glycol methacrylate (commercially available from Shin-Nakamura Co. LTD (Arimoto, Japan) under the trade designation M-20G, methoxy triethylene glycol methacrylate (commercially available from Shin-Nakamura Co. LTD (Arimoto, Japan) under the trade designation M-30G, methoxy tetraethylene glycol methacrylate (commercially available from Shin-Nakamura Co. LTD (Arimoto, Japan) under the trade designation M-40G, methoxy tripropylene glycol methacrylate (commercially available from Shin-Nakamura Co. LTD (Arimoto, Japan) under the trade designation M-30PG, butoxy diethylene glycol methacrylate (commercially available from Shin-Nakamura Co. LTD (Arimoto, Japan) under the trade designation B-20G), phenoxy ethylene glycol methacrylate (commercially available from Shin-Nakamura Co. LTD (Arimoto, Japan) under the trade designation PHE-1G), phenoxy diethylene glycol methacrylate (commercially available from Shin-Nakamura Co. LTD (Arimoto, Japan) under the trade designation PHE-2G), dicyclopentenyloxyethyl methacrylate (commercially available from Hitachi Chemical (Tokyo, Japan) under the trade designation FANCRYL FA-512M), dicyclopentanyl methacrylate (commercially available from Hitachi Chemical (Tokyo, Japan) under the trade designation FANCRYL FA-513M), isobornyl cyclohexyl methacrylate (commercially available from Designer Molecules, Inc. (San Diego, CA) as product MM-304), 4-methacryloxyethyl trimellitic anhydride (commercially available from Designer Molecules, Inc. (San Diego, CA) as product A-304, 2-methacryloxyethyl phenyl urethane (commercially available from Polysciences, Inc. (Warrington, PA), trifluoroethyl methacrylate (commercially available from Hampford Research Inc. (Stratford, CT), methacrylamide (commercially available from Evonik Performance Materials GmbH under the trade designation VISIOMER MAAmide), 2-dimethylaminoethyl methacrylate (commercially available from Evonik Performance Materials GmbH under the trade designation VISIOMER MADAME), 3-dimethylaminopropyl methacrylamide (commercially available from Evonik Performance Materials GmbH under the trade designation VISIOMER DMAPMA), and the like, and combinations thereof.

In some embodiments, the additional monofunctional (meth)acrylate monomer can act as a reactive diluent for oligomers.

In some embodiments, the additional monofunctional monomer is selected from the group consisting of methyl methacrylate, 2-hydroxyethyl methacrylate, methacrylic acid, 2-(2-butoxyethoxy)ethyl methacrylate, glycerol formal methacrylate, lauryl methacrylate, cyclohexyl methacrylate, phenyl methacrylate, phosphonate-functional (meth)acrylate monomer, and combinations thereof.

In certain embodiments of the present disclosure, the curable composition commonly comprises at least 49 wt-% of the additional monofunctional monomer. In certain embodiments of the present disclosure, the curable composition commonly comprises up to 97 wt-% of the additional monofunctional monomer.

### Crosslinkers

Crosslinkers of the present disclosure are compounds represented by the formula:

L-(R¹)_{q}

wherein each R¹ is independently selected from a functional group represented by the formula:

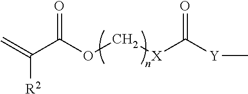

wherein:
each R² is independently hydrogen or methyl;
n is an integer from 1 to 5, inclusive;
   X is O, S, or NH; and
   Y is a single bond or a divalent group represented by the formula:

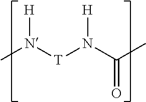

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof,
q is an integer of at least 2; and
L is an q-valent organic polymer comprising a monomer unit selected from the group consisting of monomer units represented by the formulas:

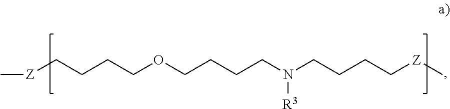

wherein R³ is a hydrogen or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH;

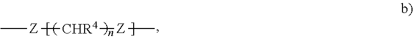

wherein n is an integer from 1 to 5, inclusive, each R⁴ is independently hydrogen or alkyl, and each Z is independently O, S, or NH;

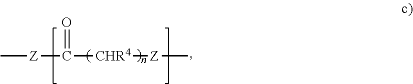

wherein n is an integer from 1 to 5, inclusive, each R⁴ is independently hydrogen or alkyl, and each Z is independently O, S, or NH;

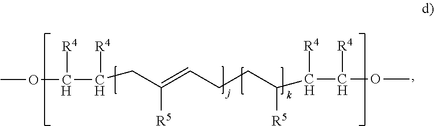

wherein j is a whole number less than or equal to 30, k is a whole number less than or equal to 30, each R⁴ is independently hydrogen or alkyl, and each R⁵ is independently a C₁₀ to C₁₅ alkyl group or a C₁₀ to C₁₅ alkenyl group, wherein j and k are not both zero, and wherein the moieties having the j and k subscripts are distributed randomly in the carbon chain;

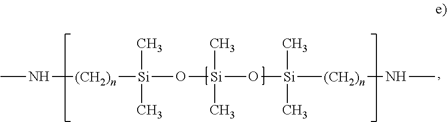

wherein m is an integer from 10 to 330 inclusive, n is an integer from 1 to 5, inclusive; and mixtures thereof.

In some embodiments, the q-valent organic polymer L comprises less than 26000 grams per mole versus a polystyrene standard of monomer unit e) if it is present.

The Z groups in monomer units a), b), and c) are bonded to R¹. If Y in R¹ is a single bond, it should be understood that the Z groups in monomer units a), b), and c) are bonded to the carbonyl group bonded to X in R¹. The —O— and —NH— groups in monomer units d) and e), respectively, are each bonded to R¹. If Y in R¹ is a single bond, it should be understood that the —O— and —NH— groups in monomer units d) and e), respectively, are bonded to the carbonyl group bonded to X in R¹. In monomer unit c), the Z outside the square bracket may be connected to a second Z group through an alkylene or heteroalkylene chain that can contain a secondary amino linkage, a tertiary amino linkage, an ether linkage, and combinations thereof. The second Z group can then be connected to R¹ or can be connected to another polymeric group made from the monomer units shown within the square brackets of c), which is then connected to R¹ through the terminal Z group. It should be understood by a person skilled in the art that the groups within the square brackets in any of the monomer units a) to e) may be repeating units. For example, the groups within the square brackets in any of the monomer units a) to c) are repeated to form a polymer.

In some embodiments, L further comprises a monomer unit selected from the group consisting of monomer units represented by the formulas:

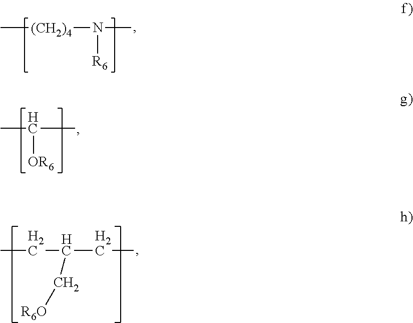

and combinations thereof, wherein each R⁶ is independently a hydrogen, a monomer unit selected from the group consisting of divalent units within the brackets of monomer units a)-e), a Z-terminated alkyl or heteroalkylene chain, and combinations thereof, wherein the Z-terminated alkyl or heteroalkylene chain may include a linkage selected from the group consisting of a secondary amino linkage, a tertiary amino linkage, an ether linkage, and combinations thereof, and wherein Z is O, S, or NH, where it is understood that monomer units f), g), and h) are not located at a terminus of L if they are present.

In some embodiments, L further comprises a monomer unit represented by the formula:

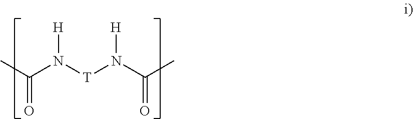

wherein T is a divalent group selected from the group consisting of a linear alkylene, a cyclic alkylene, an unsubstituted arylene, a substituted arylene, and combinations thereof. In such embodiments, L may be a block co-polymer having the general structure A-B-A-B-A, where each A represents a homopolymer including monomer units of formula b), wherein n=4, Z is O, and having an average molecular weight of 2500 to 3500 grams per mole (e.g., 2900 grams per mole) and each B represents a monomer unit represented by formula i), where it is understood that monomer unit i) is not located at a terminus of L if it is present. In some embodiments, L may have an average molecular weight of 4000-40000 grams per mole, or 8000 to 30000 grams per mole.

With respect to q-valent organic polymer L, it is understood that L may be a homopolymer or a copolymer (e.g., a block copolymer, a random copolymer). For example, a homopolymer L would include only one type of monomer unit, i.e., a), b), c), d), or e) in the polymer chain. A block copolymer could include, for example, a sequence of a) monomer units adjacent a sequence of b) monomer units forming the polymer chain. A random copolymer could include, for example, some first number of b) monomer units randomly interspersed with some second number of a) monomer units forming the polymer chain. The group within the square brackets of a), b), and c) are repeated with the number of units corresponding to the desired molecular weight of polymer L. In monomer units d) and e), the numbers j, k, and m can be any value to achieve the desired molecular weight of polymer L.

Crosslinkers of the present disclosure represented by the formula L-(R¹)_{q} may be prepared by methods know to those of ordinary skill in the relevant arts and by methods as described, for example, in Cooper, S. L. and Guan, J. (Eds) Advances in Polyurethane Biomaterials, Chapter 4, (Elsevier Ltd., 2016) and Lin et al., “UV-curable low-surface-energy fluorinated poly(urethane-acrylates)s for biomedical applications,” European Polymer Journal, Vol. 44, pp. 2927-2937 (2008). For example, a crosslinker including monomer units represented by the formulas a) and b) may be prepared by the reaction of polyether polyprimary polyamines, either obtained from 3M Company (St. Paul, MN) under the trade designation DYNAMAR HC-1101 or prepared as described in U.S. Pat. No. 3,436,359 (Hubin et al.), with 2-isocyanatoethyl methacrylate (“IEM”).

In some preferred embodiments, the q-valent organic polymer L comprises 10 wt-% to 20 wt-% of monomer unit a) monomers and at least 70 wt-% of monomer unit b) monomers. In some embodiments, the q-valent organic polymer L comprises less than 7 wt-%, less than 6 wt-%, less than 5 wt-%, less than 4 wt-%, less than 3 wt-%, less than 2 wt. %, less than 1 wt-%, or less than 0.5 wt-% of monomer unit a) monomers wherein R³ is not hydrogen. In some embodiments, the q-valent organic polymer L has a number average molecular weight of from 4000 to 54000 grams per mole versus a polystyrene standard.

In certain embodiments of the present disclosure, a curable composition includes at least 2 wt-%, or at least 5 wt-%, of the crosslinker represented by the formula L-(R¹)_{q}. In certain embodiments of the present disclosure, a curable composition includes up to 60 wt-%, or up to 50 wt-%, of the crosslinker represented by the formula L-(R¹)_{q}.

### Cure Initiator System

The curable composition further comprises a cure initiator system. In some embodiments, the cure initiator system is a redox initiator system, as one-electron transfer redox reactions may be an effective method of generating free radicals under mild conditions. Redox initiator systems have been described, for example, in Prog. Polym. Sci. 24 (1999) 1149-1204.

In some embodiments, the redox initiator system is a blend of a peroxide with an amine, where the polymerization is initiated by the decomposition of the organic peroxide activated by the redox reaction with amine reducing agent. Typically, the peroxide is benzoyl peroxide, and the amine is a tertiary amine. Aromatic tertiary amines are the most effective compounds to generate the primary radicals, with N,N-dimethyl-4-toluidine (“DMT”) being the most common amine reducing agent.

In some embodiments, the redox cure initiator system comprises a barbituric acid derivative and a metal salt. In some embodiments, the barbituric acid/metal salt cure initiator system may further comprise an organic peroxide, an ammonium chloride salt (e.g., benzyl tributylammonium chloride), or a mixture thereof.

Examples of cure initiator systems based on barbituric acid include redox initiator systems having (i) a barbituric acid derivative and/or a malonyl sulfamide, and (ii) an organic peroxide, selected from the group consisting of the mono- or multifunctional carboxylic acid peroxide esters. There can be used as barbituric acid derivatives, for example, 1,3,5-trimethylbarbituric acid, 1,3,5-triethylbarbituric acid, 1,3-dimethyl-5-ethylbarbituric acid, 1,5-dimethylbarbituric acid, 1-methyl-5-ethylbarbituric acid, 1-methyl-5-propylbarbituric acid, 5-ethylbarbituric acid, 5-propylbarbituric acid, 5-butylbarbituric acid, 1-benzyl-5-phenylbarbituric acid, 1-cyclohexyl-5-ethylbarbituric acid and the thiobarbituric acids mentioned in the German patent application DE-A-42 19 700.

The barbituric acids and barbituric acid derivatives described in U.S. Pat. No. 3,347,954 (Bredereck et al.) and U.S. Pat. No. 9,957,408 (Thompson), as well as the malonyl sulfamides disclosed in the European patent specification EP-B-0 059 451, may be useful in embodiments of the present disclosure. Preferred malonyl sulfamides are 2,6-dimethyl-4-isobutylmalonyl sulfamide, 2,6-diisobutyl-4-propylmalonyl sulfamide, 2,6-dibutyl-4-propylmalonyl sulfamide, 2,6-dimethyl-4-ethylmalonyl sulfamide or 2,6-dioctyl-4-isobutylmalonyl sulfamide.

The barbituric acid-based redox initiator systems typically contain mono- or multifunctional carboxylic acid peroxyesters as organic peroxides. Carbonic peroxyesters are also included among the multifunctional carboxylic acid peroxyesters within the meaning of the present disclosure. Suitable examples include carbonic-diisopropyl-peroxydiester, neodecanoic acid-tertiary-butyl-peroxyester, neodecanoic acid-tertiary-amyl-peroxyester, maleic acid-tertiary-butyl-monoperoxyester, benzoic acid-tertiary-butyl-peroxyester, 2-ethylhexanoic acid-tertiary-butyl-peroxyester, 2-ethylhexanoic acid-tertiary-amyl-peroxyester, carbonic-monoisopropylester-monotertiary-butyl-peroxyester, carbonic-dicyclohexyl-peroxyester, carbonic dimyristyl-peroxyester, carbonic dicetyl peroxyester, carbonic-di(2-ethylhexyl)-peroxyester, carbonic-tertiary-butyl-peroxy-(2-ethylhexyl)ester or 3,5,5-trimethylhexanoic acid-tertiary-butyl-peroxyester, benzoic acid-tertiary-amyl-peroxyester, acetic acid-tertiary-butyl-peroxyester, carbonic-di(4-tertiary-butyl-cyclohexyl)-peroxyester, neodecanoic acid-cumene-peroxyester, pivalic acid-tertiary-amyl-peroxyester and pivalic acid tertiary-butyl-peroxyester.

In particular, carbonic-tertiary-butyl-peroxy-(2-ethylhexyl)ester (commercially available from Arkema, Inc. (King of Prussia, PA) under the trade designation LUPEROX TBEC) or 3,5,5-trimethylhexanoic acid-tertiary-butyl-peroxyester (commercially available from Arkema, Inc. (King of Prussia, PA) under the trade designation LUPEROX 270) can be used as organic peroxides according to embodiments of the present disclosure.

Metal salts may be used with the barbituric acid derivative can include transition metal complexes, especially salts of cobalt, manganese, copper, and iron. When the metal salt is a copper compound, the salt may possess the general formula CuXₙ, where X is an organic and/or inorganic anion and n=1 or 2. Examples of suitable copper salts include copper chloride, copper acetate, copper acetylacetonate, copper naphthenate, copper salicylate or complexes of copper with thiourea or ethylenediaminetetraacetic acid, and mixtures thereof. In some embodiments copper naphthenate is particularly preferred.

Another redox initiator system suitable for use in embodiments of the present disclosure comprises an inorganic peroxide, an amine-based reducing agent, and an accelerator, where the amine may be an aromatic and/or aliphatic amine, and the polymerization accelerator is at least one selected from the group consisting of sodium benzenesulfinate, sodium p-toluenesulfinate, sodium 2,4,6-trisopropyl benzenesulfinate, sodium sulfite, potassium sulfite, calcium sulfite, ammonium sulfite, sodium bisulfate, and potassium bisulfate. An example of an inorganic peroxide useful in this system is peroxodisulfate as described in U.S. Pat. No. 8,545,225 (Takei et al.).

In some embodiments, the curable composition includes a cure initiator system comprising a metal salt (e.g., copper naphthenate) and an ammonium salt (e.g., benzyl tributylammonium chloride). In some embodiments, curable composition includes a cure initiator system comprising a barbituric acid derivative and a metal salt and optionally comprising at least one of an organic peroxide or an ammonium chloride salt.

If used, the components of the cure initiator system are present in the curable composition in amounts sufficient to permit an adequate free-radical reaction rate of curing of the curable composition upon initiation of polymerization, amounts which may be readily determined by one of ordinary skill in the art. Generally, the curable composition commonly comprises at least 0.1 wt-%, or at least 0.5 wt-%, of the cure initiator system. In certain embodiments of the present disclosure, the curable composition commonly comprises up to 10 wt-%, or up to 5 wt-%, of the cure initiator system.

### Additives

The curable compositions may optionally contain one or more conventional additives. Additives may include, for example, tackifiers, plasticizers, dyes, pigments, antioxidants, UV stabilizers, corrosion inhibitors, dispersing agents, wetting agents, adhesion promotors, toughening agents, and fillers.

Fillers useful in embodiments of the present disclosure include, for example, fillers selected from the group consisting of a micro-fibrillated polyethylene, a fumed silica, a talc, a wollastonite, an aluminosilicate clay (e.g., halloysite), phlogopite mica, calcium carbonate, kaolin clay, metal oxides (e.g., barium oxide, calcium oxide, magnesium oxide, zirconium oxide, titanium oxide, zinc oxide), nanoparticle fillers (e.g., nanosilica, nanozirconia), and combinations thereof.

### SELECT EMBODIMENTS OF THE PRESENT DISCLOSURE

In a first embodiment provided is curable (meth)acrylate structural adhesive composition comprising: a cyclic imide-containing (meth)acrylate monomer; a crosslinker; and a cure initiator system; wherein the crosslinker is a compound represented by the formula:

L-(R¹)_{q}
wherein each R¹ is independently selected from a functional group represented by the formula:

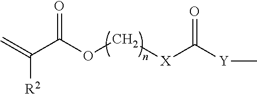

wherein:
   each R² is independently hydrogen or methyl;
   n is an integer from 1 to 5, inclusive;
   X is O, S, or NH; and
   Y is a single bond or a divalent group represented by the formula:

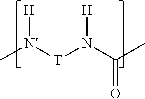

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof,
q is an integer of at least 2; and
L is an q-valent organic polymer (preferably having a number average molecular weight of from 4000 to 54000 grams per mole versus a polystyrene standard) comprising a monomer unit selected from the group consisting of monomer units represented by the formulas:

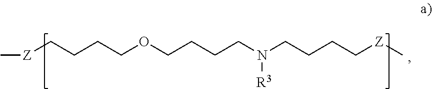

wherein R³ is a hydrogen or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH;

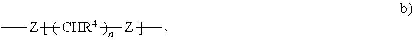

wherein n is an integer from 1 to 5, inclusive, each R⁴ is independently hydrogen or alkyl, and each Z is independently O, S, or NH;

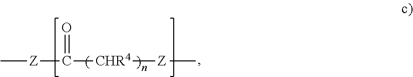

wherein n is an integer from 1 to 5, inclusive, each R⁴ is independently hydrogen or alkyl, and each Z is independently O, S, or NH;

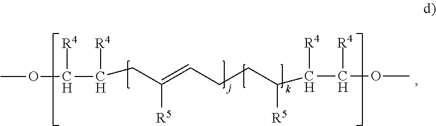

wherein j is a whole number less than or equal to 30, k is a whole number less than or equal to 30, each R⁴ is independently hydrogen or alkyl, and each R⁵ is independently a C₁₀ to C₁₅ alkyl group or a C₁₀ to C₁₅ alkenyl group, wherein j and k are not both zero, and wherein the moieties having the j and k subscripts are distributed randomly in the carbon chain;

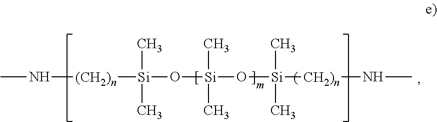

wherein m is an integer from 10 to 330 inclusive, n is an integer from 1 to 5, inclusive; and mixtures thereof.

In some embodiments, the q-valent organic polymer L comprises less than 26000 grams per mole versus a polystyrene standard of monomer unit e) if it is present.

In a second embodiment provided is the curable composition of the first embodiment wherein the q-valent organic polymer L of the crosslinker has a number average molecular weight of from 4000 to 54000 grams per mole versus a polystyrene standard. In a third embodiment provided is the curable composition of the first embodiment or the second embodiment wherein the q-valent organic polymer L of the crosslinker comprises 10 wt-% to 20 wt-% of monomer unit a) monomers. In a fourth embodiment provided is the curable composition of any one of the first through the third embodiments wherein the q-valent organic polymer L of the crosslinker comprises at least 70 wt-% of monomer unit b) monomers. In a fifth embodiment provided is the curable composition of any one of the first through the fourth embodiments wherein the q-valent organic polymer L of the crosslinker comprises less than 7 wt-%, less than 6 wt-%, less than 5 wt-%, less than 4 wt-%, less than 3 wt-%, less than 2 wt-%, less than 1 wt-%, or less than 0.5 wt-% of monomer unit a) monomers wherein R³ is not hydrogen. In a sixth embodiment provided is the curable composition of any one of the first through the fifth embodiments comprising at least 2 wt-%, or at least 5 wt-%, of the crosslinker represented by the formula L-(R¹)_{q}. In a seventh embodiment provided is the curable composition of any one of the first through the sixth embodiments comprising up to 60 wt-%, or up to 50 wt-%, of the crosslinker represented by the formula L-(R¹)_{q}.

In an eighth embodiment provided is the curable composition of any one of the first through the seventh embodiments wherein the cyclic imide-containing (meth)acrylate monomer comprises a cyclic imide group of the following formula:

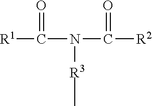

wherein R¹ and R² are joined to form a ring system that includes one or more rings (typically, two rings), and R³ is an alkylene group (e.g., a C1-C8 alkylene group, and typically, an ethylene group) bound to a (meth)acrylate group (—O—C(O)—C(R)═CH₂) wherein R═H or CH₃. In a ninth embodiment provided is the curable composition of the eighth embodiment wherein the ring system includes only aliphatic rings (typically, two aliphatic rings). In a tenth embodiment provided is the curable composition of the ninth embodiments wherein the cyclic imide-containing (meth)acrylate monomer is of the formula:

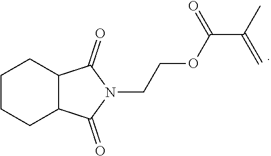 [SMILES: C=C(C)C(=O)OCCN1C(=O)C2CCCCC2C1=O]

In an eleventh embodiment provided is the curable composition of any one of the first through the tenth embodiments comprising at least 5 wt-% of the cyclic imide-containing (meth)acrylate monomer. In a twelfth embodiment provided is the curable composition of any one of the first through the eleventh embodiments comprising up to 10 wt-% of the cyclic imide-containing (meth)acrylate monomer.

In a thirteenth embodiment provided is the curable composition of any one of the first through the twelfth embodiments further comprising an additional monofunctional monomer. In a fourteenth embodiment provided is the curable composition of the thirteenth embodiment wherein the additional monofunctional monomer is selected from the group consisting of methyl methacrylate, 2-hydroxyethyl methacrylate, methacrylic acid, 2-(2-butoxyethoxy)ethyl methacrylate, glycerol formal methacrylate, lauryl methacrylate, cyclohexyl methacrylate, phenyl methacrylate, phosphonate-functional (meth)acrylate monomer, and combinations thereof. In a fifteenth embodiment provided is the curable composition of the thirteenth or the fourteenth embodiment comprising at least 49 wt-% of the additional monofunctional monomer. In a sixteenth embodiment provided is the curable composition of the thirteenth through the fifteenth embodiment comprising up to 97 wt-% of the additional monofunctional monomer.

In a seventeenth embodiment provided is the curable composition of any one of the first through the sixteenth embodiments wherein the cure initiator system comprises a free radical initiator system. In an eighteenth embodiment provided is the curable composition of the seventeenth embodiment wherein the free radical initiator system comprises a metal salt (e.g., copper naphthenate) and an ammonium salt (e.g., benzyl tributylammonium chloride). In a nineteenth embodiment provided is the curable composition of any one of the first through the eighteenth embodiments comprising at least 0.1 wt-%, or at least 0.5 wt-%, of the cure initiator system. In a twentieth embodiment provided is the curable composition of any one of the first through the nineteenth embodiments comprising up to 10 wt-%, or up to 5 wt-%, of the cure initiator system.

In a twenty-first embodiment provided is the curable composition of any one of the first through the twentieth embodiments wherein the q-valent organic polymer L further comprises a monomer unit selected from the group consisting of monomer units represented by the formulas:

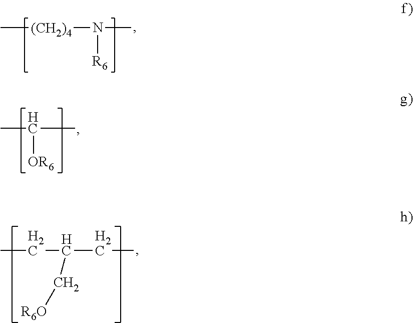

and combinations thereof, wherein each R⁶ is independently a hydrogen, a monomer unit selected from the group consisting of monomer units a)-e) and a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH.

In a twenty-second embodiment provided is the curable composition of any one of the first through the twenty-first embodiments wherein the q-valent organic polymer L further comprises a monomer unit represented by the formula:

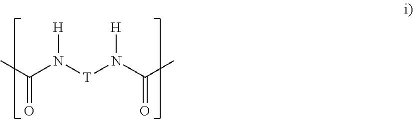

wherein T is a divalent group selected from the group consisting of a linear alkylene, a cyclic alkylene, an unsubstituted arylene, a substituted arylene, and combinations thereof.

In a twenty-third embodiment provided is the curable composition of any one of the first through the twenty-second embodiments, the composition further comprising a filler. In a twenty-fourth embodiment provided is the curable composition of the twenty-third embodiment wherein the filler is selected from the group consisting of a micro-fibrillated polyethylene, a fumed silica, talc, a wollastonite, an aluminosilicate clay, a phlogopite mica, calcium carbonate, a kaolin clay, and combinations thereof.

In a twenty-fifth embodiment provided is the curable composition of any one of the first through the twenty-fourth embodiments wherein a structural (meth)acrylate adhesive formed from the curable composition has a minimum ultimate elongation of at least 50%, at least 100%, at least 200%, or at least 400%, at least 600%, or at least 800%. In a twenty-sixth embodiment provided is the curable composition of any one of the first through the twenty-fifth embodiments wherein a structural (meth)acrylate adhesive has a minimum overlap shear strength of at least 1000 psi, at least 1100 psi, at least 1200 psi, at least 1300 psi, or at least 1400 psi.

In a twenty-seventh embodiment is provided a method of bonding a first substrate to a second substrate, the method comprising: providing a curable (meth)acrylate structural adhesive composition as described herein, and an accelerator to form a curable adhesive mixture; applying the curable adhesive mixture to at least a portion of one surface of the first substrate; covering the curable adhesive mixture at least partially with at least a portion of one surface of the second substrate; and allowing the curable adhesive mixture to cure and form a structural (meth)acrylate adhesive. In a twenty-eighth embodiment is provided the method of the twenty-seventh embodiment wherein 10 parts of the curable (meth)acrylate structural adhesive composition are mixed with 1 part of the accelerator.

In a twenty-ninth embodiment is provided the method of the twenty-seventh embodiment or the twenty-eighth embodiment wherein at least one of the first substrate or the second substrate is a glass. In a thirtieth embodiment provided is the method of any one of the twenty-seventh through the twenty-ninth embodiments wherein the first substrate and the second substrate are different materials. In a thirty-first embodiment provided is the method of the thirtieth embodiment wherein at least one of the first substrate or the second substrate is a glass and the other substrate is a metal.

In a thirty-second embodiment provided is the method of any one of the twenty-seventh through the thirty-first embodiments wherein the portion of one surface of the first substrate is not subjected to a surface treatment before applying the curable adhesive mixture thereto.

In a thirty-third embodiment provided is a bonded article comprising the structural adhesive bonded to a substrate prepared according to any one of the twenty-seventh through the thirty-second embodiments.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials

| Abbreviation | Description and Source |
|---|---|
| IEM | 2-isocyanatoethyl methacrylate obtained from Showa Denko K.K. (Tokyo, Japan) |
| | under the trade designation KARENZ MOI |
| HC-1101 | Branched poly(tetrahydrofuran) diamine with primary (1°) amine content of 7143 |
| | g/eq and total amine content of 5243 g/eq obtained from 3M Company (St. Paul, |
| | MN) under the trade designation DYNAMAR HC-1101 |
| POLYTHF | Poly(tetramethylene oxide) diol with molecular weight of approximately 2000 |
| 2000 | obtained from BASF (Florham Park, NJ) under the trade designation POLYTHF 2000 |
| TERATHANE | Poly(tetramethylene oxide) diol with molecular weight of approximately 2900 |
| 2900 | obtained from The Lycra Company (Wilmington, DE) under the trade designation |
| | TERATHANE 2900 |
| PCL H1P | Polycaprolactone diol having average molecular weight of 10,000 g/mol (OH value, |
| | KOH mg/g 13.0) obtained from Daicel USA Inc. (Fort Lee, NJ) under the trade |
| | designation PLACCEL H1P |
| F3000 | A polyfarnesene diol polymer having a molecular weight of 2720 g/mol available |
| | from TOTAL Cray Valley (Exton, PA) under the trade designation KRASOL F 3000 |
| D4000 | Amine terminated polypropylene glycol having approximate molecular weight of |
| | 4000 available from Huntsman Corporation (The Woodlands, TX) under the trade |
| | designation JEFFAMINE D-4000 |
| 1K silicone | An amine-terminated polydimethylsiloxane having a number average molecular |
| diamine | weight of approximately 1000 g/mol available from Wacker Silicones (Adrian MI) |
| | under the trade designation FLUID NH 15D |
| 5K silicone | Bis(3-aminopropyldimethyl) polydimethylsiloxane having a number average |
| diamine | molecular weight of approximately 5000 g/mol (3M Company as described in |
| | Example 2 of U.S. Pat. No. 5,214,119) |
| 25K silicone | Bis(3-aminopropyldimethyl) polydimethylsiloxane having a number average |
| diamine | molecular weight of approximately 25000 g/mol (3M Company as described in |
| | Example 2 of U.S. Pat. No. 5,214,119) |
| EC-311 | Trifunctional triamine prepared by reaction of propylene oxide with a triol initiator, |
| | followed by amination of the terminal hydroxyl groups. Available from BASF |
| | (Florham Park, NJ) under the trade designation BAXXODUR EC 311 |
| PPDA-6K | α-ω-diamino poly(tetramethylene oxide) polymer having primary amine equivalent |
| | weight AEW = 2944 g/eq. and Mn = 5888 g/mol, (both determined by titration with |
| | 1N HCl) prepared as described in U.S. Pat. No. 4,833,213 |
| PPDA-9K | α-ω-diamino polytetramethylene oxide polymer having primary amine equivalent |
| | weight AEW = 4653 g/eq. and Mn = 9126 g/mol, (both determined by titration with |
| | 1N HCl) prepared as described in U.S. Pat. No. 4,833,213 |
| DDMA | Methacrylate crosslinker obtained from methacrylate functionalization of 6000 |
| | molecular weight polyether (ethylene oxide/tetramethylene oxide 1/3-4) diol, as |
| | described in EP670341 obtained from 3M Company (St. Paul, MN) |
| ESS50F | Micro fibrillated polyethylene, hydrophilic grade, aspect ratio 20:1 length:diameter |
| | available from MiniFibers, Inc. (Johnson City, TN) under the trade designation |
| | SHORT STUFF ESS50F |
| CuNap | Copper naphthenate 8% in mineral spirits from Strem Chemicals (Newburyport, |
| | MA) |
| BYK-S 782 | Film forming additive from BYK Chemie (Wallingford, CT) |
| N + Cl— | Benzyl tributylammonium chloride from Sachem Americas (Austin, Texas) |
| XT100 | Methylmethacrylate-butadiene-styrene (MBS) core-shell toughening agent available |
| | form Arkema Inc. (King of Prussia, PA) under the trade designation |
| | CLEARSTRENGTH XT100 |
| BAYMOD N | Acrylonitrile-butadiene rubber (NBR) with calcium stearate as separating agent |
| 34.52 | available from ARLANXEO Corporation (Pittsburgh, PA) under the trade |
| | designation BAYMOD N 34.52 |
| SL300 | Hollow ceramic spheres having mean particle size of 100 micrometers from |
| | Envirospheres Pty. Ltd. (Lindfield NSW Australia) under the trade designation E- |
| | SPHERES SL300 |
| DRAGONITE | Aluminosilicate clay available from Applied Materials Inc. (Brooklyn, NY) under |
| | the trade designation DRAGONITE PURE WHITE |
| HDK H18 | Hydrophobic amorphous silica available from Wacker Silicones (Muchen Germany) |
| | under the trade designation HDK H18 |
| MEHQ | Hydroquinone monomethyl ether (4-Methoxyphenol) available from Millipore |
| | Sigma (St. Louis, MO) |
| PAM 200 | Phosphonate-functional methacrylate monomer available from Solvay Novecare |
| | (Cranbury, NJ) under the trade designation SIPOMER PAM-200 |
| HEMA | 2-hydroxyethyl methacrylate available from Evonik Performance Materials GmbH |
| | (Essen Germany) under the trade designation VISIOMER HEMA 97 |
| CHMA | Cyclohexyl methacrylate available from Evonik Performance Materials GmbH |
| | (Essen Germany) under the trade designation VISIOMER c-HMA |
| 2-EHMA | 2-ethylhexyl methacrylate, Evonik Performance Materials GmbH |
| LMA | Lauryl methacrylate available from BASF (Florham Park, NJ) under the trade |
| | designation LMA 1214 F. |
| BDGMA | 2-(2-Butoxyethoxy)ethyl methacrylate available from Evonik Performance Materials |
| | GmbH (Essen Germany) under the trade designation VISIOMER BDGMA |
| M1041 | Phenyl methacrylate available from Miwon North America (Exton, PA) under the |
| | trade designation MIRAMER M1041 |
| 4-tBu-CHMA | 4-tert-butylcyclohexyl methacrylate, Miwon North America |
| TriMe-CHMA | 3,3,5-trimethylcyclohexyl methacrylate, Miwon, North America |
| PROSTAB | Polymerization inhibitor, 4-hydroxy-2,2,6,6-tetramethyl-piperidinooxy, available |
| 5198 | from BASF (Florham Park, NJ) under the trade designation PROSTAB 5198 |
| M1088 | 2-(hexahydrophthalimido)ethyl acrylate available from Miwon North America |
| | (Exton, PA) under the trade designation MIRAMER M1088 |
| M1089 | 2-(hexahydrophthalimido)ethyl methacrylate available from Miwon North America |
| | (Exton, PA) under the trade designation MIRAMER M1089 |

### Analytical Procedures

### Attenuated Total Reflectance (“ATR”) FTIR Spectroscopy Measurements

ATR-FTIR measurements were recorded using a Thermo Nicolet iS50 FTIR (Thermo Fisher Scientific Co., Waltham, MA, USA) spectrometer equipped with a single-bounce diamond crystal and a deuterated triglycine sulfate detector. One drop of each liquid sample was placed directly on the surface of the diamond ATR crystal, and the evanescent wave could be absorbed by the liquid sample. The resulting attenuated radiation produced an ATR spectrum similar to a conventional absorption spectrum.

### Transmission-FTIR Spectroscopy Measurements

Transmission-FTIR measurements were recorded using Thermo Nicolet iS5 System FTIR (Thermo Fisher Scientific Co., Waltham, MA) spectrometer. Samples are prepared by diluting an aliquot of a reaction in toluene to provide a solution, spreading the solution onto a salt plate, and drying under nitrogen stream.

### Gel Permeation Chromatography

Polymers were analyzed by gel permeation chromatography (GPC) using Reliant GPC (Waters e2695 pump/autosampler) with Waters 2424 evaporative light scattering detector and PL-Gel-2 Columns; 300×7.5 mm each; one 3 μm Mixed-E (nominal MW range up to 30,000 Daltons) and one 5 μm Mixed-D (nominal MW range 200-400,000 Daltons). At 40° C. in tetrahydrofuran stabilized with 250 ppm of BHT relative to polystyrene standards.

### Overlap Shear Test

Each sample formulation was separately loaded into the 10-part side of a 10:1 dual syringe cartridge dispenser, using the accelerator from 3M SCOTCH-WELD DP8410NS Acrylic Adhesive (3M Company) in the 1-part side of the dispenser in each case. All bonds were prepared by dispensing the sample formulation and accelerator through a static mixing tip. The resulting adhesives were used to prepare samples for the Overlap Shear Test samples on grit-blasted aluminum, IPA-wiped glass, or IPA-wiped fritted glass substrates. Overlap shear samples were 2.54 cm×10.16 cm×0.16 cm aluminum, glass, or fritted glass coupons using 0.076-0.0127 mm spacer beads with a 1.27 cm overlap. The bond line was clamped with binder clips during cure and the clips were removed after 24 hours at 25° C. Testing was run on a 5000 lb (22 kN) load cell for overlap shear. The values are an average of three specimens.

### Tensile Testing of Cured Films

Films of cured compositions were prepared by combining in a polypropylene Max100 DAC cup (part number 501 221 from FlackTek, Inc., Landrum, SC) 40 g of a sample formulation and 4 g accelerator from SCOTCH-WELD DP8410NS Acrylic Adhesive (3M Company, St. Paul, MN). The cup was closed with a polypropylene lid and the mixture was high-shear mixed at ambient temperature and pressure using a FlackTek, Inc. SPEEDEMIXER (DAC 400.2 VAC) for 25 seconds at 1500 rpm (revolutions per minute). The resulting mixtures were coated between silicone-treated polyester release liners at approximately 1 mm thickness. The coated films were allowed to sit at room temperature a minimum of 24 hours before testing. Tensile elongation measurements were performed according to ASTM Standard D638-14 “Standard Test Method for Tensile Properties of Plastics,” 2015 using a TYPE-V die for specimen cutting, and a 100 mm/minute crosshead test speed.

### Dynamic Mechanical Analysis (“DMA”) Test

Film samples were prepared using the films prepared for the Tensile Testing as described above. Film samples were cut to approximately 6-7 mm width×1 mm thick×50 mm length and tested on a DMAQ800 (TA Instruments Inc., New Castle, DE) using a dual cantilever fixture with the following settings: frequency=1 Hz, oscillation amplitude=15 μm, and minimum oscillation force=0.02 N. The film samples were equilibrated to −75° C. and held at that temperature for five minutes, followed by a temperature ramp of 3.0° C./minute to 200° C. The Glass Transition Temperature (T_{q}) was found by examining the maximum peak height of the Tan δ curve.

### Preparative Example 1: Preparation of Methacryloxyurea-terminated Branched Diamine Poly(tetrahydrofuran) (“HC-1101/IEM”)

DYNAMAR HC-1101 (“HC-1101”) was heated at 65° C. to melt the solid material and reduce its viscosity. Melted HC-11101 (245.0 g) was charged in a 3-necked, round bottom flask equipped with distillation head, thermocouple, and overhead stirrer. The flask was sparged with nitrogen and heated to 70° C. To the highly viscous, heated HC-1101 methylethylketone (60 mL) was added with stirring. Afterwards, the same amount of methylethylketone was distilled off under vacuum to provide dried HC-1101. To the dried HC-1101, 2-isocyanatoethyl methacrylate (“IEM”) (5.32 g) was added dropwise under nitrogen and stirring was continued at 70° C. for 16 hours. Isocyanate consumption was monitored by Transmission-FTIR Spectroscopy. The resulting material was drained at 70° C. to afford 196.2 g (78% yield) viscous, light-yellow oil, HC-1101/IEM, that solidified upon cooling to ambient temperature.

### Alternative Crosslinkers

The following crosslinkers can be prepared as alternatives to that of Preparative Example 1. Although these were not incorporated into a curable (meth)acrylate structural adhesive composition that includes a cyclic imide-containing (meth)acrylate monomer, it is believed they would provide similar results to that of Preparative Example 1.

### Alternative Preparative Example 2: Preparation of Methacrylate-Functional Purely Primary Poly(tetramethylene oxide) Diamines (“PPDA-6K/IEM” and “PPDA-9K/IEM”)

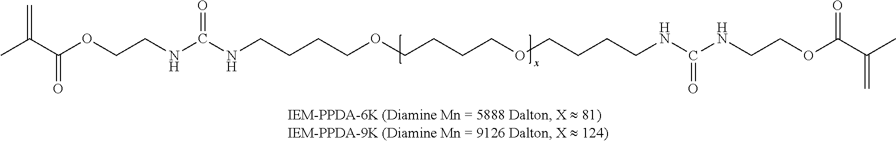

TABLE 2
PPDA-6K/IEM Reagents

| | Molecular | | Total | | | | | Theoretical | | Actual | |
|---|---|---|---|---|---|---|---|---|---|---|---|
| Material | Weight | | Amine | | 1° amine | | Equivalents | Charge | | Charge | |
| PPDA-6K | 5888 | g/mol | 2944 | g/eq | 2944 | g/eq | 0.042 eq | 122.50 | g | 122.50 | g |
| IEM | 155.15 | g/mol | 155.15 | g/eq | 155.15 | g/eq | 0.042 eq | 6.46 | g | 6.42 | g |
| PROSTAB | | | | | | | | 36.75 | mg | 44.00 | mg |
| 5198 | | | | | | | | | | | |

Linear polytetrahydrofuran diamine PPDA-6K (122.5 g), prepared as described in U.S. Pat. No. 4,833,213 (Leir et al.) is added to a 500 mL resin flask equipped with thermocouple, stainless steel mechanical stirrer, and vacuum adapter. Heat the flask to 75° C. and keep under high vacuum overnight (14 hours). Refill flask with dry air and add PROSTAB 5198 (44.0 mg). Mix well and cool the flask to 50° C. Remove from heat. Add 2-isocyanatoethyl methacrylate (6.42 g) and stir in well. As the 2-isocyanatoethyl methacrylate is mixed, the previously clear viscous oil turns opaque. After 30 minutes all of the isocyanate was consumed as evidenced by Transmission-FTIR Spectroscopy. Material is drained to afford 125.8 g (98% yield) of an opaque, viscous oil that solidifies upon cooling.

TABLE 3
PPDA-9K/IEM Reagents

| | Molecular | | Total | | | | | Theoretical | | Actual | |
|---|---|---|---|---|---|---|---|---|---|---|---|
| Material | Weight | | amine | | 1° amine | | Equivalents | Charge | | Charge | |
| PPDA-9K | 9126 | g/mol | 4563 | g/eq | 4563 | g/eq | 0.018 eq | 82.07 | g | 82.07 | g |
| IEM | 155.15 | g/mol | 155.15 | g/eq | 155.15 | g/eq | 0.018 eq | 2.79 | g | 2.85 | g |
| PROSTAB | | | | | | | | 24.62 | mg | 23.30 | mg |
| 5198 | | | | | | | | | | | |

Linear polytetrahydrofuran diamine PPDA-9K (82.07 g), prepared as described in U.S. Pat. No. 4,833,213 (Leir et al.) is added to a 500 mL resin flask equipped with thermocouple, stainless steel mechanical stirrer, and vacuum adapter. Heat flask to 75° C. and keep under high vacuum overnight (16 hours). Refill flask with dry air and add PROSTAB 5198 (23.3 mg). Mix well and cool the flask to 50° C. Remove from heat. Add 2-isocyanatoethyl methacrylate (2.85 g) and stir in well. After 30 minutes all of the isocyanate is consumed as evident by Transmission-FTIR Spectroscopy. Material is drained to afford 80.0 g (94% yield) of a viscous light-yellow oil that solidifies upon cooling.

### Alternative Preparative Example 3: Synthesis of Methacryloxyurea-terminated Silicone Methacrylate (“MAUS-1K/IEM,” “MAUS-5K/IEM,” and “MAUS-25K/IEM”) Crosslinkers

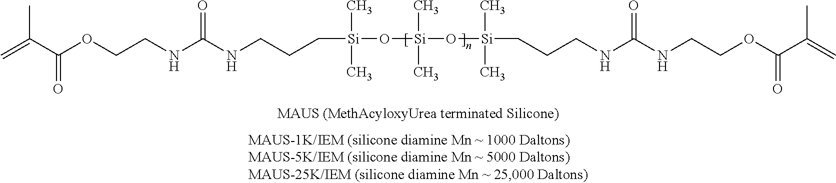

TABLE 4
Silicone Diamine/IEM Reagents

| Silicone Diamine | Silicone Diamine | |
|---|---|---|
| Identity | Amount (g) | IEM Amount (g) |
| 1K silicone diamine* | 50.0 | 14.0 |
| 5K silicone diamine** | 50.0 | 3.0 |
| 25K silicone diamine** | 100.0 | 1.08 |

*Commercially available from Wacker Silicones (Adrian, MI) under the trade designation FLUID NH 15D.
**Prepared as described in Example 2 of U.S. Pat. No. 5,214,119 (Leir et al.).

For each material, the silicone diamine and 2-isocyanatoethyl methacrylate (“IEM”) are added to a polypropylene MAX 200 DAC cup (part number 501 220p-j from FlackTek, Inc., Landrum, SC) in the amounts as listed in Table 4. The cups are closed with a polypropylene lid and the mixtures are high-shear mixed at ambient temperature and pressure using a FlackTek, Inc. SPEEDMIXER (DAC 400.2 VAC) for one minute at 2000 rpm. After mixing, the mixtures become warm from the exothermic reaction. The mixtures are allowed to react under ambient conditions for at least 24 hours prior to use.

### Alternative Preparative Example 4: Synthesis of Methacrylate-functional Poly(tetramethylene oxide) Diols (“THF 2000/IEM” and “THF 2900/IEM”)

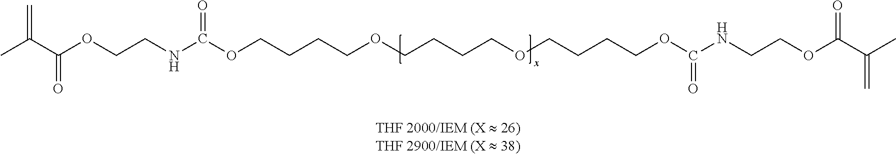

Methacrylate-functional poly(tetramethylene oxide) diols were prepared using poly(tetramethylene oxide) diols of two molecular weights, 2000 g/mol and 2900 g/mol, using the following procedure.

TABLE 5
THF 2000/IEM and THF 2900/IEM Reagents

| Diol Identity | Diol Amount (g) | IEM amount (g) |
|---|---|---|
| POLYTHF 2000 | 170.02 | 26.46 |
| TERATHANE 2900 | 180.02 | 19.28 |

The diols are heated at 70° C. to melt. The amounts of melted diol listed in Table 5 are transferred to polypropylene MAX 200 DAC cups (part number 501 220p-j from FlackTek, Inc., Landrum, SC), a separate cup for each diol, followed by addition of the amount of isocyanatoethyl methacrylate (“IEM”) listed in Table 5. The cups are closed with a polypropylene lid and the mixtures are high-shear mixed at ambient temperature and pressure using a FlackTek, Inc. SPEEDMIXER (DAC 400.2 VAC) for one minute at 2000 rpm. The closed containers are held at 60° C. in an oven. The reaction mixtures are monitored over time using attenuated total reflectance (“ATR”) FTIR Spectroscopy. The total reaction time is 17 hours, after which time ATR shows the disappearance of the isocyanate -NCO peak at approximately 2264 cm⁻¹ and the OH peaks at 3500 cm⁻¹ and appearance of NH peaks at 3400 cm⁻¹, confirming that the reactions are completed.

### Alternative Preparative Example 5: Synthesis of Methacrylate-functional PLACCEL H1P (“PCL H1P/IEM”)

A 10,000 molecular weight poly(caprolactone)diol is methacrylate functionalized using the procedure described above for the poly(tetramethylene oxide) diols, where PLACCEL H1P (200 g) is combined with 2-isocyanatoethyl methacrylate (7.19 g) at 80° C. for 4 hours.

### Alternative Preparative Example 6: Synthesis of Methacrylate-functional D4000 (“D4000/IEM”)

To a polypropylene MAX 200 DAC cup (part number 501 220p-j from FlackTek, Inc., Landrum, SC), is added JEFFAMINE D4000 (100 g), 2-isocyanatoethyl methacrylate (7.8 g), and MEHQ (0.25 g). The cup is closed with a polypropylene lid and the mixture is high-shear mixed at ambient temperature and pressure using a FlackTek, Inc. SPEEDMIXER (DAC 400.2 VAC) for one minute at 2000 rpm. After mixing, the mixture becomes warm from the exothermic reaction. The methacrylate is allowed to react under ambient conditions for at least 24 hours prior to use.

### Alternative Preparative Example 7: Synthesis of Methacrylate-functional EC311 (“EC311/IEM”)

To a polypropylene MAX 200 DAC cup (part number 501 220p-j from FlackTek, Inc., Landrum, SC), is added EC311 (100 g), 2-isocyanatoethyl methacrylate (8.0 g), and MEHQ (0.25 g). The cup is closed with a polypropylene lid and the mixture is high-shear mixed at ambient temperature and pressure using a FlackTek, Inc. SPEEDMIXER (DAC 400.2 VAC) for one minute at 2000 rpm. After mixing, the mixture becomes warm from the exothermic reaction. The methacrylate is allowed to react under ambient conditions for at least 24 hours prior to use.

### Alternative Preparative Example 8: Synthesis of Methacrylate-functional Polyfarnesene Diol (“F3000/IEM”)

To a polypropylene MAX 200 DAC cup (part number 501 220p-j from FlackTek, Inc., Landrum, SC), is added poly(farnesene) F3000 (100 g) and 2-isocyanatoethyl methacrylate (11.4 g). The cup is closed with a polypropylene lid and the mixture is high-shear mixed at ambient temperature and pressure using a FlackTek, Inc. SPEEDMIXER (DAC 400.2 VAC) for one minute at 2000 rpm. The closed container is held at 70° C. in an oven. The reaction mixture is monitored over time using attenuated total reflectance (“ATR”) FTIR Spectroscopy. The total reaction time is 7 hours, after which time ATR shows the disappearance of the isocyanate -NCO peak at approximately 2264 cm⁻¹ and the OH peaks at 3500 cm⁻¹ and appearance of NH peaks at 3400 cm⁻¹, confirming that the reaction is completed.

### Examples (Ex.) 1 to 3 and Illustrative Examples (Ill. Ex.) A to F

Examples Ex. 1 to 3 and Illustrative Examples Ill. Ex. A to F were prepared by combining the components of Table 6 in a polypropylene MAX 200 DAC cup (part number 501 220 from FlackTek, Inc. After capping with a polypropylene lid, the mixtures were mixed, three times, in a SPEEDMIXER (DAC 400.2 VAC from FlackTek, Inc.) for one minute at 1500 revolutions per minute with hand stirring using a wood tongue depressor between mixes. The samples were degassed by capping with a polypropylene lid that contained a vent hole, and high-shear mixed under reduced pressure (35 Torr).

TABLE 6
Formulation for Examples 1 to 3 and Illustrative Examples A to F

| | Ill. Ex. A | Ill. Ex. B | Ill. Ex. C | Ex. 1 | Ill. Ex. D | Ill. Ex. E | Ex. 2 | Ill Ex. F | Ex. 3 |
|---|---|---|---|---|---|---|---|---|---|
| | (g) | (g) | (g) | (g) | (g) | (g) | (g) | (g) | (g) |
| BDGMA | 19 | | | | 19 | 19 | 19 | 19 | |
| LMA | | 19 | | | | | | | |
| 2-EHMA | | | 19 | | | | | | |
| 4-tBu-CHMA | | | | | 19 | | | | |
| TriMe-CHMA | | | | | | 19 | | | |
| M1041 | | | | | | | | 19 | |
| M1089 | | | | 19 | | | 19 | | |
| M1088 | | | | | | | | | 19 |
| CHMA | 19 | 19 | 19 | 19 | | | | | 19 |
| HEMA | 19 | 19 | 19 | 19 | 19 | 19 | 19 | 19 | 19 |
| Baymod | 6 | 6 | 6 | 6 | 6 | 6 | 6 | 6 | 6 |
| XT100 | 6 | 6 | 6 | 6 | 6 | 6 | 6 | 6 | 6 |
| HC1101-IEM | 9.25 | 9.25 | 9.25 | 9.25 | 9.25 | 9.25 | 9.25 | 9.25 | 9.25 |
| CuNap | 0.1 | 0.1 | 0.1 | 0.1 | 0.1 | 0.1 | 0.1 | 0.1 | 0.1 |
| N + Cl− | 1 | 1 | 1 | 1 | 1 | 1 | 1 | 1 | 1 |
| MEHQ | 0.05 | 0.05 | 0.05 | 0.05 | 0.05 | 0.05 | 0.05 | 0.05 | 0.05 |
| PAM200 | 3 | 3 | 3 | 3 | 3 | 3 | 3 | 3 | 3 |
| ESS50F | 1 | 1 | 1 | 1 | 1 | 1 | 1 | 1 | 1 |
| H18 | 1.2 | 1.2 | 1.2 | 1.2 | 1.2 | 1.2 | 1.2 | 1.2 | 1.2 |
| Dragonite | 15.1 | 15.1 | 15.1 | 15.1 | 15.1 | 15.1 | 15.1 | 15.1 | 15.1 |
| SL300 | 0.3 | 0.3 | 0.3 | 0.3 | 0.3 | 0.3 | 0.3 | 0.3 | 0.3 |

### Sample Films and Bond Testing

Film coatings incorporating Examples and Comparative Examples of Table 6 were prepared using the procedure described above. Testing procedures for Tensile Elongation Measurements and Dynamic Mechanical Analysis (“DMA”) using the prepared film coatings are described above. Sample film testing results are shown in Tables 7 and 8 below.

TABLE 7
Results from Tensile Elongation Measurements on Films of Cured Compositions

| | | Tensile Stress | Elongation | |
|---|---|---|---|---|
| | | @ 25% | at Break | Modulus |
| Example | Monomer Mix | (psi) | (%) | (psi) |
| Ill. Ex. A | BDGMA/CHMA/HEMA | 1171.1 | 48.3 | 36749 |
| Ill. Ex. B | LMA/CHMA/HEMA | 1027.8 | 62.5 | 24178 |
| Ill. Ex. C | 3-EHMA/CHMA/HEMA | 1481.5 | 37.6 | 57492 |
| Ex. 1 | M1089/CHMA/HEMA | 3079.8 | 23.98 | 25057 |
| Ill. Ex. D | BDGMA/tBuCHMA/HEMA | 1248.0 | 56.1 | 48066 |
| Ill. Ex. E | BDGMA/3-MeCHMA/HEMA | 902.9 | 80.1 | 29861 |
| Ex. 2 | BDGMA/M1089/HEMA | 732.2 | 69.42 | 20978 |
| Ill. Ex. F | BDGMA/M1041/HEMA | 583.1 | 91.4 | 12164 |
| Ex. 3 | M1088/CHMA/HEMA | 1688.9 | 59.7 | 21134 |

TABLE 8
Dynamic Mechanical Analysis (“DMA”)
Data for Films of Cured Compositions

| | | DMA | Width at |
|---|---|---|---|
| | | (tan δ) | half height |
| Sample | Monomer Mix | (° C.) | (° C.) |
| Ill. Ex. A | BDGMA/CHMA/HEMA | 62.76 | 41.36 |
| Ill. Ex. B | LMA/CHMA/HEMA | 85.98 | N.M. |
| Ill. Ex. C | 3-EHMA/CHMA/HEMA | 61.49 | 53.23 |
| Ex. 1 | M1089/CHMA/HEMA | 78.34 | 50.31 |
| Ill. Ex. D | BDGMA/tBuCHMA/HEMA | 58.80 | 45.12 |
| Ill. Ex. E | BDGMA/3-MeCHMA/HEMA | 46.35 | 45.61 |
| Ex. 2 | BDGMA/M1089/HEMA | 46.18 | 38.74 |
| Ill. Ex. F | BDGMA/M1041/HEMA | 37.73 | 41.18 |
| Ex. 3 | M1088/CHMA/HEMA | 57.72 | 42.70 |

N.M.—data was too broad to measure

Bonds incorporating the Examples and Illustrative Examples of Table 6 were prepared between glass, fritted glass, and aluminum coupons using the procedure described above. The procedure for the Overlap Shear Test is described above with the testing results shown in Table 9 below.

TABLE 9
Overlap Shear Values

| | | Overlap Shear (psi), Failure Mode (FM) | | | | |
|---|---|---|---|---|---|---|
| Sample | Monomer Mix | Glass/Glass | | Glass/Aluminum | Glass/Aluminum | |
| Ill. Ex. A | BDGMA/CHMA/HEMA | 1129 | (AF) | 2188 (CF) | 1935 | (CF) |
| Ill. Ex. B | LMA/CHMA/HEMA | 1023 | (AF) | 1745 (CF) | 1689 | (SF) |
| Ill. Ex. C | 3-EHMA/CHMA/HEMA | 1631 | (CF) | 1771 (SF) | 1759 | (SF) |
| Ex. 1 | M1089/CHMA/HEMA | 2109 | (SF) | 2829 (SF) | 1911 | (SF) |
| Ill. Ex. D | BDGMA/tBuCHMA/HEMA | 2116 | (MF) | 1854 (CF) | 1512 | (CF) |
| Ill. Ex. E | BDGMA/3-MeCHMA/HEMA | 1659 | (CF) | 1896 (CF) | 1906 | (CF) |
| Ex. 2 | BDGMA/M1089/HEMA | 1288 | (CF) | 1807 (CF) | 1780 | (SF) |
| Ill. Ex. F | BDGMA/M1041/HEMA | 1490 | (CF) | 1424 (AF) | 1534 | (SF) |
| Ex. 3 | M1088/CHMA/HEMA | 867 | (AF) | 1560 (AF) | 999 | (AF) |

AF = Adhesive Failure,
SF = Substrate Failure,
CF = Cohesive Failure

The data in Tables 7 through 9 show that the formulations containing the crosslinkers and monomers of the present disclosure can yield adhesives having excellent adhesion to glass without the use of a primer or surface modification.

### Glass/Glass Overlap Sheer (“OLS”) Aging Test

Example formulation 1 or 2, prepared as described above, was loaded into the 10-part side of a 10:1 dual syringe cartridge dispenser, using the accelerator from 3M SCOTCH-WELD DP8410NS Acrylic Adhesive (3M Company, St. Paul MN) in the 1-part side of the dispenser. All bonds were prepared by dispensing the adhesive composition and accelerator through a static mixing tip. The adhesives were used to prepare overlap shear aging test samples on fritted glass and white painted aluminum substrates prepared with an isopropanol wipe. Overlap shear samples having 0.5 inch (1.27 cm) overlap were prepared on glass coupons (¼ inch (0.635 mm) thick×1 inch (25.4 mm) wide×4 inch (101.6 mm) long). The bond line was clamped with binder clips during cure and the clips were removed after 24 hours at 25° C. The glass test samples were conditioned at 77° F. (25° C.) and 50% relative humidity for 3 days, then placed in weathering chambers. Measurements were then taken at 3 weeks on a 5000 lb (22 kN) load cell for overlap shear (“OLS Aging Result”). The samples were allowed to equilibrate for 24 hours after removal form the chambers. The values are an average of three specimens. Data are shown in Table 10.

TABLE 10
Overlap Shear Results with Heat and Humidity Aging

| Sample | Aging Time and Conditions | OLS Aging Result (psi) | |
|---|---|---|---|
| Ex. 1 | 500 hours, 250° F., 30% RH (dry oven) | 793 | (S.F.) |
| Ex. 1 | 500 hours, 150° F., 80% RH | 1127 | (S.F.) |
| Ex. 1 | 10 cycles - 150° F. (constant), cycling between | 1714 | (S.F.) |
| | 30% RH and 80% RH, 6 hours/cycle | | |
| Ex. 2 | 3 weeks, 250° F., 50% RH | 1142 | (S.F.) |
| Ex. 2 | 500 hours, 150° F., 80% RH | 461 | (A.F. to glass) |
| Ex. 2 | 10 cycles - 150° F. (constant), cycling between | 615 | (A.F. to glass) |

30% RH and 80% RH, 6 hours/cycle

S.F. = substrate failure,
A.F. = adhesive failure

It was expected that a methacrylate-monomer based adhesive, such as an adhesive prepared with Example 1 or 2, would hydrolyze upon heat/humidity aging, i.e., 150° F. (66° C.) and 85% relative humidity, and thus lower the OLS values as the aging continued. Surprisingly, the data in Table 10 show that an adhesive prepared using Example 1 does not behave in this manner and suggest that adhesive formulations of the present disclosure may have utility as sealants and advanced weathering structural adhesives.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A curable (meth)acrylate structural adhesive composition comprising: a cyclic imide-containing (meth)acrylate monomer; a crosslinker; and a cure initiator system;
wherein the crosslinker is a compound represented by the formula:
L-(R¹)_{q}
wherein each R¹ is independently selected from a functional group represented by the formula: 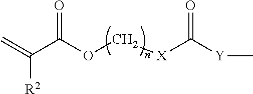
wherein:
each R² is independently hydrogen or methyl;
n is an integer from 1 to 5, inclusive;
X is O, S, or NH; and
Y is a single bond or a divalent group represented by the formula: 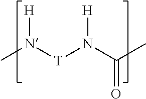
wherein:
N′ is a nitrogen bonded to the carbonyl carbon of R¹; and
T is a divalent group selected from the group consisting of a linear alkylene, a cyclic alkylene, an unsubstituted arylene, a substituted arylene, and combinations thereof,
q is an integer of at least 2; and
L is an q-valent organic polymer comprising a monomer unit represented by the formula: 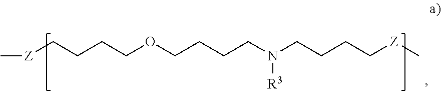
wherein R³ is a hydrogen or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH; 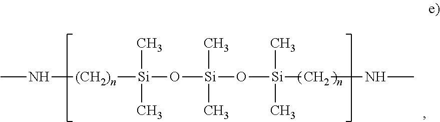
wherein m is an integer from 10 to 330 inclusive, n is an integer from 1 to 5, inclusive; or
mixtures thereof.

2. The curable composition of claim 1, wherein the q-valent organic polymer L of the crosslinker has a number average molecular weight of from 4000 to 54000 grams per mole versus a polystyrene standard, or wherein the q-valent organic polymer L comprises less than 26000 grams per mole versus a polystyrene standard of monomer unit e) if it is present.

3. The curable composition of claim 1, comprising at least 2 weight percent and up to 60 weight percent of the crosslinker represented by the formula L-(R¹)_{q}.

4. The curable composition of claim 1, wherein the cyclic imide-containing (meth)acrylate monomer is of the formula:

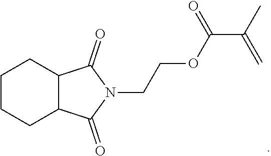 [SMILES: C=C(C)C(=O)OCCN1C(=O)C2CCCCC2C1=O]

5. The curable composition of claim 1, comprising at least 5 weight percent and up to 50 weight percent of the cyclic imide-containing (meth)acrylate monomer.

6. The curable composition of claim 1, further comprising an additional monofunctional monomer.

7. The curable composition of claim 6, wherein the additional monofunctional monomer is selected from the group consisting of methyl methacrylate, 2-hydroxyethyl methacrylate, methacrylic acid, 2-(2-butoxyethoxy)ethyl methacrylate, glycerol formal methacrylate, lauryl methacrylate, cyclohexyl methacrylate, phenyl methacrylate, phosphonate-functional (meth)acrylate monomer, and combinations thereof.

8. The curable composition of claim 6, comprising at least 49 weight percent and up to 97 weight percent of the additional monofunctional monomer.

9. The curable composition of claim 1, wherein the cure initiator system comprises a free radical initiator system.

10. The curable composition of claim 9, wherein the free radical initiator system comprises a metal salt and an ammonium salt.

11. The curable composition of claim 1, comprising at least 0.1 weight percent and up to 10 weight percent of the cure initiator system.

12. The curable composition of claim 1, further comprising a filler.

13. A method of bonding a first substrate to a second substrate, the method comprising:
combining a curable (meth)acrylate structural adhesive composition of claim 1 and an accelerator to form a curable adhesive mixture;
applying the curable adhesive mixture to at least a portion of one surface of the first substrate;
covering the curable adhesive mixture at least partially with at least a portion of one surface of the second substrate; and
allowing the curable adhesive mixture to cure and form a structural (meth)acrylate adhesive.

14. The method of claim 13, wherein at least one of the first substrate or the second substrate is a glass.

15. A bonded article comprising the structural adhesive bonded to a substrate prepared according to the method of claim 13.

16. The curable composition of claim 1, wherein the q-valent organic polymer L of the crosslinker comprises the monomer unit represented by formula a).

17. The curable composition of claim 16, wherein the q-valent organic polymer L of the crosslinker comprises less than 7 weight percent the monomer unit represented by formula a) in which R³ is not hydrogen.

18. The curable composition of claim 1, wherein the q-valent organic polymer L of the crosslinker further comprises a monomer unit represented by formula b): 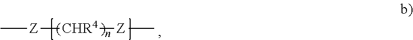
wherein n is an integer from 1 to 5, inclusive, each R⁴ is independently hydrogen or alkyl, and each Z is independently O, S, or NH.

19. The curable composition of claim 18, wherein the q-valent organic polymer L of the crosslinker comprises at least 70 weight percent of the monomer unit represented by formula b).

20. The curable composition of claim 19, wherein the q-valent organic polymer L of the crosslinker comprises 10 weight percent to 20 weight percent of the monomer unit represented by formula a).
